(19) United States
(12) Patent Application Publication
(10) Pub. No.: US 2012/0226934 A1
(43) Pub. Date: Sep. 6, 2012

(54) MISSION CRITICAL NAND FLASH

(76) Inventor: G. R. Mohan Rao, Richardson, TX (US)

(21) Appl. No.: 13/037,521

(22) Filed: Mar. 1, 2011

(51) Int. Cl. G06F 12/00; G06F 11/16

(52) U.S. Cl. 714/6.11; 711/103; 714/E11.055; 711/E12.008

(57) ABSTRACT

A flash controller reliably stores data in NAND FLASH by encoding data using an encoding algorithm, and storing that data across multiple pages of the memory. In one embodiment, true data is accepted by the controller, and the controller in turn creates coded data that is the bit-for-bit complement of the true data. The true data and the coded data are then written to the NAND FLASH on a page by page basis. A property of the coding techniques used is that, in at least some cases, detected errors can be corrected.

### CROSS REFERENCE TO RELATED APPLICATIONS

This application incorporates by reference U.S. Pat. No. 7,855,916 filed on Oct. 22, 2008 by inventor G. R. Mohan Rao, and issued on Dec. 21, 2010.

### FIELD OF THE INVENTION

The present invention relates to a system and method for providing reliable storage, and more particularly to a system and method of providing reliable storage of digital information using NAND FLASH.

### DESCRIPTION OF THE PRIOR ART

Non-volatile memories provide long-term storage of data. In the past, this has primarily been limited to storage of small programs, such as a computer BIOS, or to storage of small amounts of rarely changed data, such as configuration information. However, process improvements now permit NAND FLASH to challenge the dominance of rotating magnetic media; i.e., so called, hard disk drives. In particular, 4 Gbit (Billions-of-Bits) NAND FLASH chips are now common, with economical 16 Gbit and 32 Gbit chips quickly gaining market share. In fact, NAND FLASH is now used in a wide variety of applications, including portable storage, digital photography, cellular phones, and portable music players to name a few.

The vast majority of NAND FLASH utilizes a single level cell (SLC) architecture. However, multi-level cell (MLC) FLASH is gaining in popularity. MLC allows a single cell to store multiple bits, and accordingly, to assume more than two values; i.e., ‘0’ or ‘1’. Most MLC NAND FLASH architectures allow up to 4 values per cell; i.e., ‘00’, ‘01’, ‘10’, or ‘11’, Generally, MLC NAND FLASH enjoys greater density than SLC NAND FLASH, at the cost of a decrease in access speed and lifetime.

NAND FLASH devices are generally fragmented into a number of identically sized blocks, each of which is further segmented into some number of pages. For example, a block may comprise 32 to 64 pages, each of which incorporates 2-4 KB of memory. In addition, the process of writing data to a NAND FLASH is complicated by the fact that, during normal operation, erased bits, which are usually all bits in each cell to ‘1’, can only be changed to the opposite state, which is usually ‘0’, once before the entire block must be erased. Blocks can only be erased in their entirety, and, when erased, are usually written to ‘1’ bits.

While NAND FLASH has made great strides in gaining acceptance as a mass storage technology, present devices suffer from a number of drawbacks that stand in the way of replacing rotating magnetic drives. In particular, when a block fails, present memories do not include any automatic way to detect the failure. Accordingly, most NAND FLASH controllers include a method to track the number of P/E cycles that a particular block has been subjected to, and, when the PIE limit has been exceeded, remove the block from use. Further, while FLASH memories generally include a specification as to how many PIE cycles they can withstand, failures do occur at earlier times. In addition, when a failure does occur, it is very difficult, and in some cases impossible, to recover the proper contents of the corrupted block.

To at least partially alleviate this problem, most NAND FLASH devices incorporate a forward error correction algorithm, such as a parity check. Briefly, forward error correction algorithms attempt to ensure reliability by utilizing additional information that is stored along with the stored data. For example, some NAND FLASH devices incorporate line and column parity bits, so that all written lines or columns must, when passed through an XOR gate produce a ‘1’ or ‘0’, depending on the particular scheme implemented. One example of such a scheme is discussed in “NAND FLASH ECC ALGORITHM,” by Samsung Electronics, published on or about June of 2004, and hereby incorporated by reference in its entirety.

Erasure codes are algorithms that allow the encoding of n partitions of data, which are sometimes referred to as “true data,” onto an additional m partitions of data, which are sometimes referred to as “coded data” with the benefit of allowing the true data to be recovered even if any m partitions of data should fail. Known erasure code algorithms include Reed-Solomon, Cauchy-Reed-Solomon, and Low Density Parity Check (LDPC) algorithms, such as those described within “On the Practical Use of LDPC Erasure Codes for Distributed Storage Applications,” by James Plank and Michael G. Thomason, published on or about Sep. 23, 2003, and which is hereby incorporated by reference in its entirety. To provide further background to the reader on this subject, the presentation “T1: Erasure Codes for Storage Applications,” by James S. Plank, presented at the 4^{th} Usenix Conference on File and Storage Technologies, on or about Dec. 13, 2005, is also hereby incorporated by reference in its entirety.

### OBJECTS OF THE INVENTION

An object of the invention is to provide a system that allows for reliable data storage in NAND FLASH.

Another object of the invention is to provide a NAND FLASH that provides an indication as to when a particular block has failed.

Another object of the invention is to provide a system that allows for the proper contents of a failed block in a NAND FLASH to be recovered.

Another object of the invention is to provide a reliable solid state memory with an ability to recover its contents in the event of a failure.

Other advantages of the disclosed invention will be clear to a person of ordinary skill in the art. It should be understood, however, that a system, method, or apparatus could practice the disclosed invention while not achieving all of the enumerated advantages, and that the protected invention is defined by the claims.

### SUMMARY OF THE INVENTION

The disclosed invention achieves its objectives through a system that reliably stores data in NAND FLASH. The system comprises at least one NAND FLASH module coupled to a flash controller. The flash controller accepts data from an interface and then writes coded data to the NAND FLASH. In one embodiment, the flash controller writes true data to one page and coded data to a different page, for each page of accepted data. Furthermore, the coded data may be a true copy of the accepted data or a bit-for-bit complement of the true data. In a separate embodiment, the coded data is generated using an erasure coding algorithm, and may incorporate true data, as well as coded data.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a simplified schematic view of a system depicting a prior art system utilizing NAND FLASH;

FIG. 2 is a simplified schematic view of an embodiment of the disclosed invention utilizing a system including multiple NAND modules;

FIG. 3 is a simplified schematic view of an embodiment of the disclosed invention utilizing a NAND module having multiple planes;

FIG. 4 is a simplified schematic view of an embodiment of the disclosed invention utilizing a NAND module having multiple blocks;

FIG. 5 is a simplified schematic view of an embodiment of the disclosed invention utilizing a system including multiple NAND modules, each holding a separate code partition; and

FIG. 6 is a simplified schematic view of an embodiment of the disclosed invention utilizing a NAND module having multiple blocks, each holding a separate code partition.

### DETAILED DESCRIPTION OF THE ILLUSTRATED EMBODIMENT

The present invention relates to the reliable storage of data in read and write memories, and, in particular, to the reliable storage of data in NAND FLASH. Generally, in addition to the true data D_{T} coded data D_{C} is stored as well. In varying embodiments of the disclosed invention the coded data can be stored with or separate from the true data. In one embodiment of the disclosed invention, a partition of true data is stored in one location, and a partition of coded data, which may be the complement of the true data or the same as the true data, is stored in a separate location. By comparing the true partition with the coded partition, errors in the true data can quickly be identified and, in some cases, corrected.

Turning to the Figures, and to FIG. 1 in particular, a prior art NAND FLASH system is depicted. A processor 12 interfaces to a flash controller 14 using, for example, a data bus, a packet link, or some other interface. The flash controller 14 interfaces to one or more NAND FLASH modules 16a-c. Note that while three are depicted, practically any number of NAND FLASH modules may be interfaced to by the flash controller.

Each NAND FLASH module 16a-c may be partitioned into multiple planes, usually 2 in presently available configurations, and each plane may hold multiple blocks as depicted. In normal operation, the processor 12 issues read and write commands to the flash controller 14, which accesses the NAND FLASH modules 16a-c. The flash controller 14 also maintains information about the contents of the NAND FLASH modules 16a-c, including, for example, information on the number of program I erase cycles that a particular block has been subjected to.

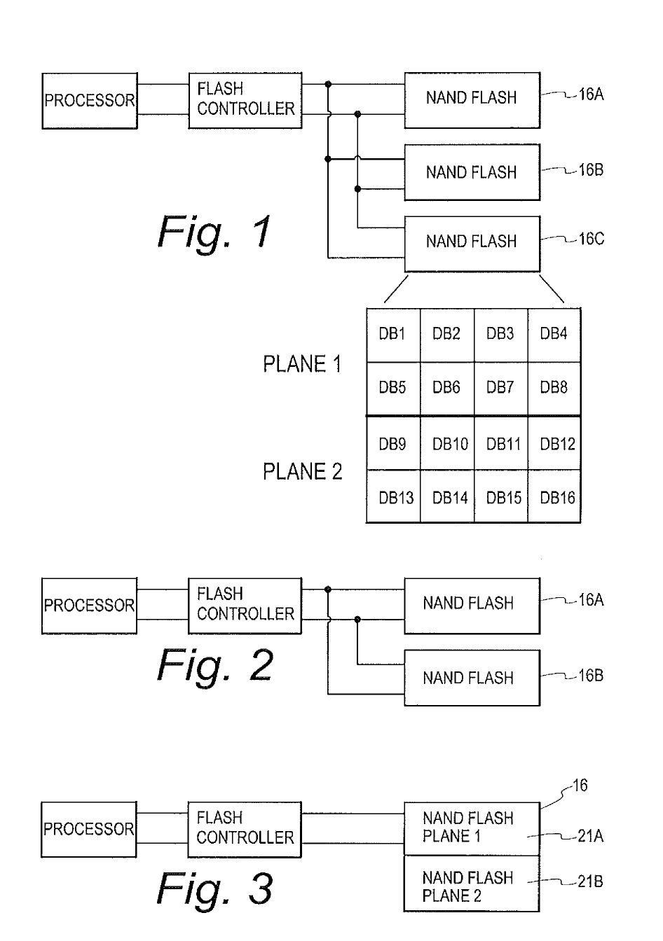

FIGS. 2-4 depicts multiple embodiments of the present invention. In these embodiments, the stored data is increased by 100%, as a page of coded data is stored for each page of true data. In these embodiments, true data is written by the processor 12 to the flash controller 14, which then creates a coded copy of the true data. The coded copy may be a true copy or a complementary copy; i.e., the exact bitwise inverse of the true data. This allows for robust error checking, as each true page can be compared against its coded counterpart using, for example, an XOR function, and if a test is failed, the page can be identified as corrupted, by verifying each page of the block.

In addition to aiding in identifying a corrupted page, the coded data page along with a basic property of NAND FLASH memory can be utilized to reconstruct a corrupted page. Generally, failed bits in FLASH memory fail by improperly transitioning from a ‘0’ (programmed state) to a ‘1’ (erased state), and rarely, if ever, fail by transitioning from a ‘1’ to a ‘0’. This property can be utilized to reconstruct a corrupted block. For example, assuming that the coded data is a bit-for-bit complement of the true data, the following logic can be used to reconstruct a corrupted data block:

True Bit=1, Coded Bit=1, Recovered Bit=1

True Bit=1, Coded Bit=0, Recovered Bit=1

True Bit=0, Coded Bit=1, Recovered Bit=0

True Bit=0, Coded Bit=0, Recovered Bit=0

It should be pointed out that the last scenario; i.e., where both the true bit and the coded bit are ‘0’ requires that a ‘1’ bit transitioned to a ‘0’ bit. It should also be pointed out that this scenario should be exceptionally rare, and through the use of the technology claimed in U.S. Pat. No. 7,855,916, earlier included by reference, In particular, true and complement blocks could be guaranteed to be stored in physically separated locations through the use of address indirection.

FIG. 2 depicts an embodiment of the disclosed invention where true data is segregated from coded data by storage in separate NAND FLASH modules 16a,b. As depicted only two NAND FLASH modules 16a,b are shown, but, it should be clear that in this embodiment, any even number of NAND FLASH modules could be used, dependent on the amount of data to be stored.

FIG. 3 depicts an embodiment of the disclosed invention where true data is segregated from coded data by storage in separate NAND FLASH planes 21a,b. As depicted, NAND FLASH module 16 incorporates a first NAND FLASH plane 21a and a second NAND FLASH plane 21b. True data is stored in one plane (which does not matter), and coded data is stored in the other plane, on a page by page basis. In this embodiment, any number of NAND FLASH modules may be used, dependent on the amount of data to be stored.

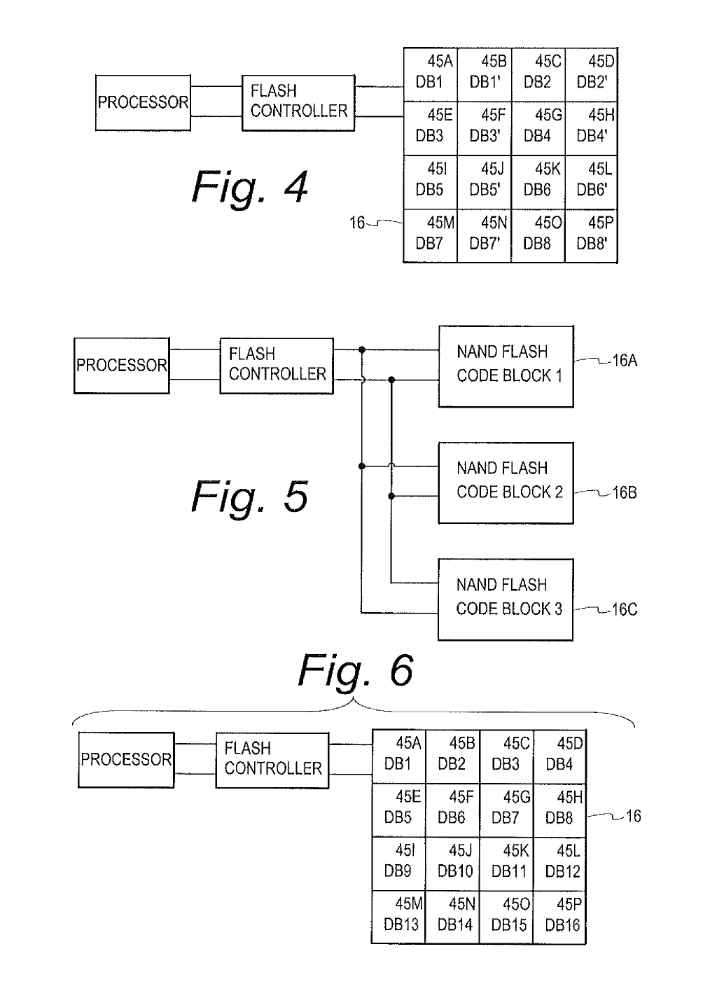

FIG. 4 depicts an embodiment of the disclosed invention where true data is segregated from coded data by storage in separate pages 45a-p of NAND FLASH module 16. While NAND FLASH module 16 is depicted as including 16 blocks, each of which will incorporate multiple pages, in practice, it will include many more, and the number of blocks in a particular NAND FLASH module is not a limitation of the disclosed invention. Further, while true data and corresponding coded data is shown as being stored in contiguous blocks, no such limitation should be read into the invention.

FIGS. 5 and 6 depict additional embodiments of the disclosed invention. These embodiments utilize erasure coding algorithms, such as, for example, Reed-Solomon, Cauchy-Reed-Solomon, or Low Density Parity Check (LDPC) algorithms, such as those described within “On the Practical Use of LDPC Erasure Codes for Distributed Storage Applications,” by James Plank and Michael G. Thomason, published on or about Sep. 23, 2003, and which is hereby incorporated by reference in its entirety. It should be understood that the particular erasure coding algorithm that is used is not significant to the invention.

Erasure coding algorithms, such as those enumerated in the previous paragraph, generally intersperse coded data with true data, and have the advantage of allowing the true data to be recovered even though some portion of the coded partitions become corrupted. Accordingly, all partitions in Figures are referred to as coded partitions, although it should be understood that each partition may contain some or all true data. In the embodiments of FIGS. 5 and 6, rrue data is written by the processor 12 to the flash controller 14, which executes the erasure coding algorithm and produces coded data that is written to the NAND FLASH modules 16.

FIG. 5 depicts an embodiment of the disclosed invention wherein different coded partitions are contained in separate NAND FLASH modules 16a-c. While three NAND FLASH modules are depicted, it should be understood that any number of NAND FLASH modules may be used, based on the amount of storage required. In this embodiment, each coded partition produced by the used erasure algorithm would be stored in a separate NAND FLASH module 16a-c.

FIG. 6 depicts an embodiment of the disclosed invention wherein different partitions are contained within different blocks 45a-p of a NAND FLASH module 16. While sixteen blocks 45a-p are depicted, it should be understood that a normal NAND FLASH module will contain a different number, and the particular number of blocks is not a limitation of the invention. In this embodiment, each coded partition produced by the used erasure algorithm would be stored in a separate block 45a-p of the NAND FLASH module 16.

While the various embodiments of the disclosed invention have been discussed as segregating coded and true data into separate devices, planes, or blocks, situations will likely arise where a portion of a container; i.e., a device, plane, or block, will contain both coded and true data in varying proportions. It should be understood that the examples provided are only illustrative, and the specific placement of coded or true data is not a limitation of the invention.

Obviously, many modifications and variations of the present invention are possible in light of the above teachings. Thus, it is to be understood that, within the scope of the appended claims, the invention may be practiced otherwise than is specifically described above.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A system for reliably storing data comprising:
i) at least one NAND FLASH module;
ii) a flash controller coupled to said at least one NAND FLASH module and including an interface for accepting data wherein said flash controller is adapted to (1) accept true data using said interface, (2) create coded data from said true data, and (3) write said coded data to said at least one NAND FLASH module.

2. The system of claim 1 wherein said flash controller is adapted to write said true data to said NAND FLASH module and wherein said coded data is a true copy of the true data.

3. The system of claim 1 wherein said flash controller is adapted to write said true data said NAND FLASH module and wherein said coded data is a complement of the true data.

4. The system of claim 1 wherein said flash controller further comprises an error recovery algorithm.

5. A system for reliably storing data comprising:
i) at least one NAND FLASH module;
ii) a flash controller coupled to said at least one NAND FLASH module and including an interface for accepting data wherein said flash controller is adapted to encode said data with an erasure coding algorithm and write said coded data to said at least one NAND FLASH module.

6. A method of reliably storing data in at least one NAND FLASH module operating on a flash controller comprising the steps of:
i) accepting true data;
ii) creating coded data from said true data; and
iii) writing said coded data to said at least one NAND FLASH module.

7. The method of claim 6 wherein said coded data is a true copy of the true data and further comprising the step of writing the true data to said at least one NAND FLASH module.

8. The method of claim 6 wherein said coded data is a complement of the true data and further comprising the step of writing the true data to said at least one NAND FLASH module.

9. A method of reliably storing data in at least one NAND FLASH module operating on a flash controller comprising the steps of:
i) accepting data;
ii) creating coded data by performing an erasure coding algorithm on said accepted data; and
iii) writing said coded data to said at least one NAND FLASH module.

10. A flash controller for controlling at least one NAND FLASH module comprising:
i) an interface for accepting data; and
ii) wherein said flash controller is adapted to (1) accept true data using said interface, (2) create coded data from said true data, and (3) write said coded data to said at least one NAND FLASH module.

11. The flash controller of claim 10 wherein said flash controller is adapted to write said true data to said NAND FLASH module and wherein said coded data is a true copy of the true data.

12. The flash controller of claim 10 wherein said flash controller is adapted to write said true data to said NAND FLASH module and wherein said coded data is a complement of the true data.

13. The flash controller of claim 10 wherein said flash controller further comprises an error recovery algorithm.

14. A flash controller for controlling at least one NAND FLASH module comprising:
i) an interface for accepting data; and
ii) wherein said flash controller is adapted to encode said data with an erasure coding algorithm and write said coded data to said at least one NAND FLASH module.
